(19) United States
(12) Patent Application Publication
(10) Pub. No.: US 2024/0049105 A1
(43) Pub. Date: Feb. 8, 2024

(54) METHOD FOR UE COMMUNICATION PATH SELECTION

(71) Applicant: ZTE Corporation, Shenzhen (CN)

(72) Inventor: Hao DONG, Shenzhen (CN)

(73) Assignee: ZTE Corporation, Shenzhen, GD (CN)

(21) Appl. No.: 18/218,483

(22) Filed: Jul. 5, 2023

Related U.S. Application Data
(63) Continuation of application No. PCT/CN2021/074173, filed on Jan. 28, 2021.

(51) Int. Cl. H04W 40/12; H04W 76/14; H04W 74/08

(52) U.S. Cl. CPC H04W 40/12; H04W 76/14; H04W 74/0833

(57) ABSTRACT

Method, systems and devices for selecting, by a first wireless communication terminal, a first wireless communication path or a second wireless communication path for a service to communicate with a second wireless communication terminal according to a path status. The first wireless communication path is a direct communication path between the first wireless communication terminal and the second wireless communication terminal, and the second wireless communication path is a communication path between the first wireless communication terminal and the second wireless communication terminal via a random access network and a corresponding core network.

### CROSS-REFERENCE TO RELATED APPLICATIONS

This application is a continuation of International Patent Application No. PCT/CN2021/074173, filed Jan. 28, 2021. The contents of PCT/CN2021/074173 are incorporated herein by reference in their entirety.

### TECHNICAL FIELD

This document is directed generally to wireless communications.

### BACKGROUND

When a user equipment (UE) is close to another UE, these two UEs can communicate to each other directly via a proximity service (ProSe) communication. The ProSe communication allows new communication paths established via a PCS interface between two or more ProSe-enabled UEs that are in communication range. For a SG system (SGS), the proximity services are expected to be an important system supporting various applications and services (in both commercial and public safety domains).

When two UEs communicate with each other, there are two different paths which could be used: Uu communication path (via Radio Access Network (RAN) and Core Network) and PCS communication path (UEs exchange data directly).

Thus, how to choose an appropriate communication path for the communication between two UEs with ProSe capability should be considered.

### SUMMARY

This document relates to methods, systems, and devices for selecting a communication path between wireless communication terminals.

One aspect of the present disclosure relates to a wireless communication method. In an embodiment, the wireless communication method includes: selecting, by a first wireless communication terminal, a first wireless communication path or a second wireless communication path for a service to communicate with a second wireless communication terminal according to a path status. The first wireless communication path is a direct communication path between the first wireless communication terminal and the second wireless communication terminal, and the second wireless communication path is a communication path between the first wireless communication terminal and the second wireless communication terminal via a random access network and a corresponding core network.

Another aspect of the present disclosure relates to a wireless communication terminal. In an embodiment, the wireless communication terminal includes a communication unit and a processor. The processor is configured to select a first wireless communication path or a second wireless communication path for a service to communicate with a second wireless communication terminal according to a path status, wherein the first wireless communication path is a direct communication path between the first wireless communication terminal and the second wireless communication terminal, and the second wireless communication path is a communication path between the first wireless communication terminal and the second wireless communication terminal via a random access network and a corresponding core network.

Preferably, the first wireless communication path is a communication path between the first wireless communication terminal and the second wireless communication terminal via a PCS interface.

Preferably, the second wireless communication path is a communication path between the first wireless communication terminal and the second wireless communication terminal via a Uu interface.

Preferably, the path status comprises at least one of: whether a first link via the first wireless communication path exists, or whether a second link via the second wireless communication path exists.

Preferably, if either a first link via the first wireless communication path or a second link via the second wireless communication path is not existing, the path status comprises at least one of: a first link quality in the first wireless communication path, or a second link quality in the second wireless communication path.

Preferably, if either a first link via the first wireless communication path or a second link via the second wireless communication path is not existing, the path status comprises at least one of: a first link quality of a PCS interface in the first wireless communication path, or a second link quality of a Uu interface in the second wireless communication path.

Preferably, the first wireless communication terminal is configured to use a first link via the first wireless communication path for the service to communicate with the second wireless communication terminal in response to the first link existing.

Preferably, the first wireless communication terminal is configured to transmit a PCS unicast link modification request to the second wireless communication terminal to use the first link for the service.

Preferably, the first wireless communication terminal is configured to use a second link via the second wireless communication path for the service to communicate with the second wireless communication terminal in response to the second link existing.

Preferably, the first wireless communication terminal is configured to initiate a PDU session modification process to use the second link for the service.

Preferably, the first wireless communication terminal is configured to use a first link via the first wireless communication path for the service to communicate with the second wireless communication terminal in response to a path selection policy indicating that the first wireless communication path is a preferred path for the service.

Preferably, the first wireless communication terminal is configured to use a first link via the first wireless communication path for the service to communicate with the second wireless communication terminal in response to a first link quality of the first wireless communication path being better than a second link quality of the second wireless communication path.

Preferably, the first wireless communication terminal is configured to perform a PCS unicast link establishment process to establish the first link for the service.

Preferably, the first wireless communication terminal is configured to use a second link via the second wireless communication path for the service to communicate with the second wireless communication terminal in response to a path selection policy indicating that the second wireless communication path is a preferred path for the service.

Preferably, the first wireless communication terminal is configured to use a second link via the second wireless communication path for the service to communicate with the second wireless communication terminal in response to a second link quality of the second wireless communication path being better than a first link quality of the first wireless communication path.

Preferably, the first wireless communication terminal is configured to perform a PDU session establishment process to establish the second link for the service.

Preferably, there is no link on the first wireless communication path and the second wireless communication path available for the service.

Preferably, the first wireless communication terminal is configured to perform a link quality measurement for a PCS interface to acquire a first link quality of the first wireless communication path.

Preferably, the first wireless communication terminal is configured to perform a link quality measurement for a Uu interface to acquire a second link quality of the second wireless communication path.

Preferably, a path selection policy indicates that both of the first wireless communication path and the second wireless communication path are able to be selected for the service to communicate with the second wireless communication terminal.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a path selection procedure according to an embodiment of the present disclosure.

FIG. 2 shows a schematic diagram of a path selection procedure according to an embodiment of the present disclosure.

FIG. 3 shows a schematic diagram of a path selection procedure according to an embodiment of the present disclosure.

FIG. 4 shows an example of a schematic diagram of a wireless terminal according to an embodiment of the present disclosure.

In some embodiments of the present disclosure, the communication path may indicate path or interface.

### DETAILED DESCRIPTION

To determine which communication path shall be used for communications between two UEs, a simple way is choosing the communication path according to services between these two UEs. For example, an interactive gaming requiring cloud computing needs to be bound to the Uu communication path (e.g., an interface between a UE and a base station (e.g., gNB)) while a chatting application used in the UE is suitable for using the PCS communication path (e.g., an interface between UEs). The policy for the path selection between the PCS communication path and the Uu communication paths may be included in a service authorization provisioning policy/parameter to the UE of solutions. The policy may include a mapping from the services to the PCS communication path and/or the Uu communication path. That is, based on the policy, single service may be limited to use only the PCS communication path, use only the Uu communication path, or both the PCS communication path and the Uu communication path could be used.

In addition to the abovementioned approach for path selection which simply determines the communication path based on the services, there are also other approaches determine the policy of the path selection may in response to other parameters: quality of service (QoS) notification control from a network node (e.g., next generation radio access network (NG-RAN) node); analytics result notification from a network data analysis function (NWDAF), such as QoS sustainability for all UEs in an area of interest; and/or network performance analytics on the gNB status information. The UE checks the policy rules and selects an appropriate communication path (e.g., the PCS communication path or the Uu communication path) accordingly.

However, these approaches determine the communication path based on only static policies without considering dynamic situations of the UE while performing the path selection.

In an embodiment of the present disclosure, the UE receives the policy regarding the path selection from a policy control function (PCF) and determines a communication path for a new service on the UE according to the path selection policy when the new service requests for communications.

The new service on the UE has a need to communicate with a peer UE and the UE checks the path selection policy and finds both the PCS communication path and Uu communication path could be used for this new service. In an embodiment, the UE finds that there is already a PCS unicast link between this UE and the peer UE which could be used for the new service and the UE updates the PCS unicast link to accommodate the new service.

As an alternative, the UE finds there is already a PDU session oriented to the peer UE through the Uu interface and this PDU session could be used for the new service. Under such conditions, the UE modifies the PDU session to accommodate the new service.

In an embodiment, neither the existing PCS communication path nor the existing Uu communication path is available for the new service, the UE checks the path selection policy to determine whether there is a preferred path for the new service. If there is a preferred path for the new service, the UE selects the preferred path as the communication path for the new service. As an alternative or in addition, the UE compares the link quality of the PCS communication path and that of the Uu communication path and chooses the communication path with better link quality as the communication path for this new service. In an embodiment, the PCS communication path is selected, the UE establishes a new unicast PCS unicast link oriented to the peer UE for the new service. In an embodiment, the Uu communication path is selected, the UE establishes a new PDU session oriented to the peer UE for the new service.

In an embodiment, when the UE has no knowledge about the link quality of both the PCS communication path and the Uu communication path, the UE chooses the communication path based on a pre-configuration or implementation of the UE.

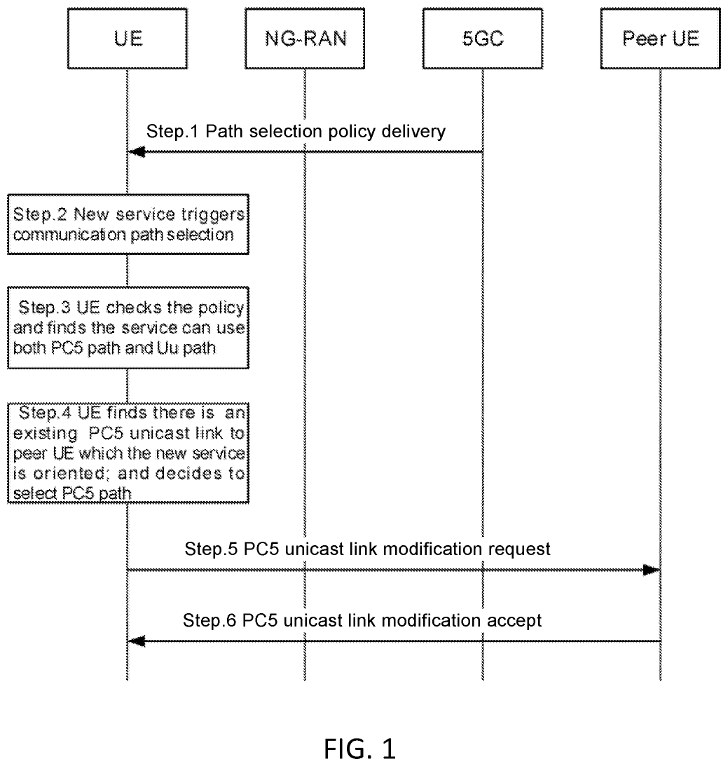

FIG. 1 shows a schematic diagram of a path selection procedure according to an embodiment of the present disclosure. In the embodiment corresponding to FIG. 1, the PCS communication path is selected as the communication path between the UE and the peer UE for the service.

More specifically, the PCF in a 5G core network (5GC) delivers the path selection policy to the UE (step 1). The path selection policy includes a mapping from services to the PCS communication path and/or to the Uu communication path. That is, based on the policy, the services may be limited to use only the PCS communication path, use only the Uu communication path, or both the PCS communication path and the Uu communication path could be used.

In step 2, a new service on the UE is triggered to communicate to the peer UE and the UE determines which communication path should be used for the new service: the PCS communication path or Uu communication path.

In step 3, the UE checks the path selection policy for the communication path(s) available to the new service. In this embodiment, the new service can use both the PCS communication path and the Uu communication path.

In step 4, the UE finds that there is an existing PCS unicast link to peer UE to which the new service is oriented. The UE checks the existing PCS unicast link and confirms that the existing PCS unicast link is capable of being used for the new service. The UE selects the PCS communication path as the communication path for this new service.

In step 5, the UE sends a PCS unicast link modification request to the peer UE, to associate the existing PCS unicast link with the new service.

In step 6, the peer UE responds a PCS unicast link modification accept message to the UE. After these steps, the data exchange of this new service between the UE and the peer UE is carried on the existing PCS unicast link.

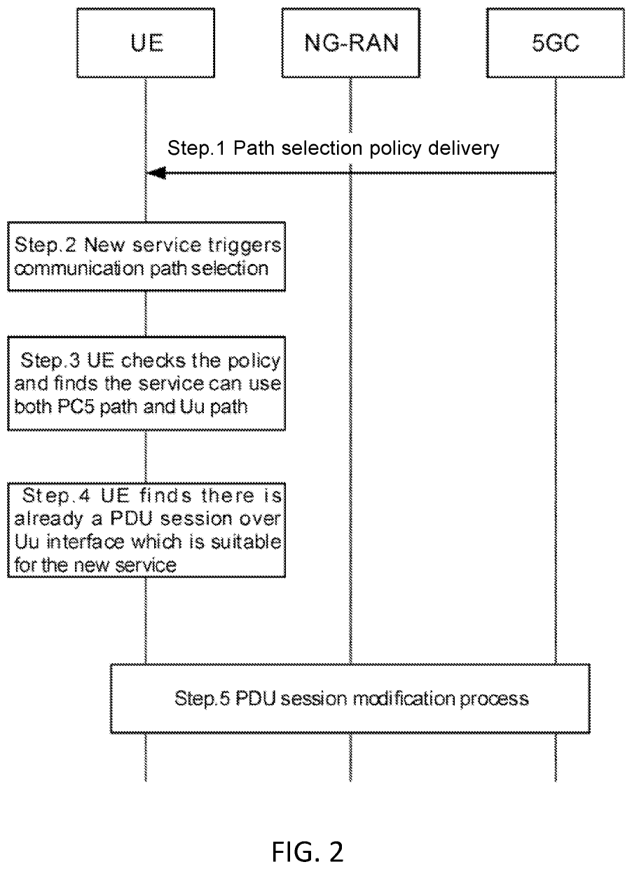

FIG. 2 shows a schematic diagram of a path selection procedure according to an embodiment of the present disclosure. In FIG. 2, the Uu communication path is selected as the communication path between the UE and the peer UE.

Specifically, the steps 1 to 3 are the same as those in FIG. 1.

In step 4, the UE finds there is an existing PDU session over the Uu interface used to communicate with the peer UE which is the same as the destination of the new service. The UE checks the existing PDU session and confirms that the existing PDU session could be used for the new service. The UE selects the Uu communication path as the communication path for this new service.

In step 5, the UE initiates a PDU session modification process with the NG-RAN and the 5GC, to associate the existing PDU session with the new service.

After these steps, the data exchange of this new service between the UE and the peer UE is carried on the Uu communication path through the PDU session.

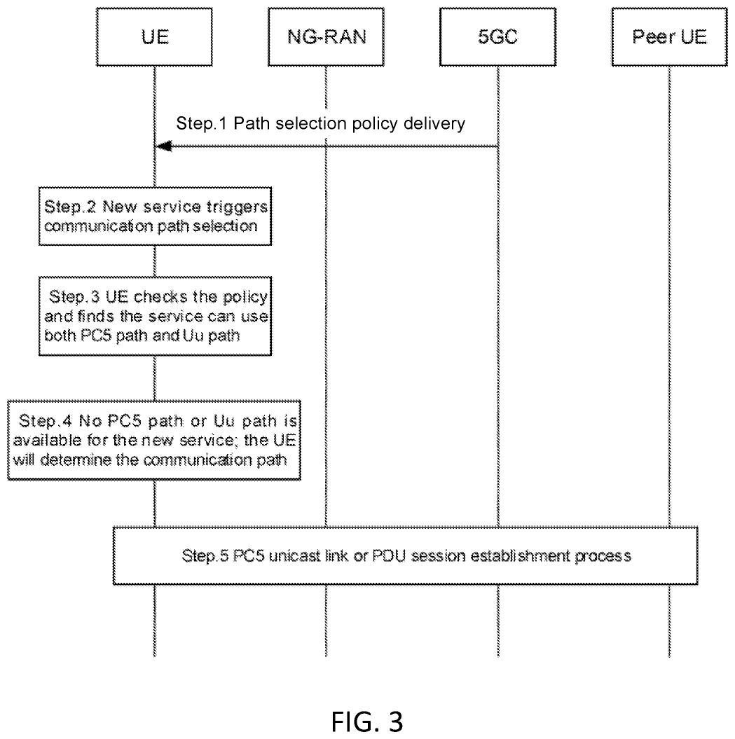

FIG. 3 shows a schematic diagram of a path selection procedure according to an embodiment of the present disclosure. In FIG. 3, a new communication path is established for communications between the UE and the peer UE.

In detail, the steps I to 3 are the same as those in FIG. 1.

In step 4, if there is neither existing link on the PCS communication path (e.g., unicast link) nor existing link on the Uu communication path (e.g., PDU session) available for the new service, the UE determines which communication path (i.e., PCS communication path or Uu communication path) can be used according to the following conditions.

In an embodiment, the UE checks the path selection policy to determine whether there is a preferred path for the new service. If there is a preferred path for the new service, the UE selects the preferred path as the communication path for the new service.

In an embodiment, if there is no preferred path for the new service in the path selection policy, the UE will perform a link quality measurement for the PCS interface and the Uu interface and selects the communication path which has better link quality.

In an embodiment, if the UE has no knowledge about the link quality of the PCS interface and the Uu interface, the UE will determine the communication path according to pre-configured information or implementation of the UE.

In step 5, the UE performs an establishment process of one of the PCS unicast link or the PDU session for the new service.

After these steps, the data exchange of this new service between the UE and the peer UE is carried on the new established PCS unicast link or Uu communication path through the PDU session.

In an embodiment, a new service on the UE has a need to communicate with the peer UE and the UE checks the path selection policy and determines that both the PCS communication path and the Uu communication path could be used for this new service. If the UE finds that there is already a PCS unicast link between this UE and peer UE which could be used for the new service, the UE updates the PCS unicast link to accommodate the new service.

As an alternative, if the UE finds there is already a PDU session oriented to the peer UE through the Uu interface and this PDU session could be used for the new service, the UE will modify the PDU session to accommodate the new service.

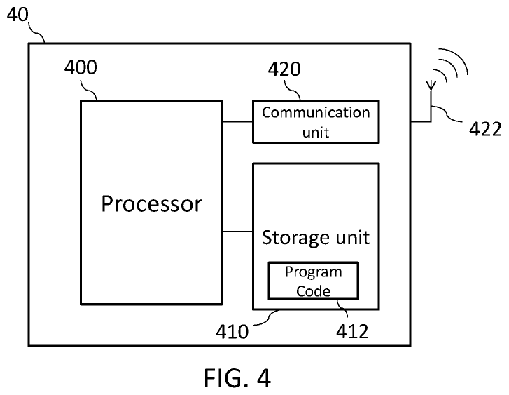

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 412 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g., messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code. The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g., a base station) or another wireless communication terminal (e.g., another UE).

A wireless communication method is also provided according to an embodiment of the present disclosure. In an embodiment, the wireless communication method may be performed by using a wireless communication terminal. In an embodiment, the wireless communication terminal may be implemented by using the wireless communication terminal 40 described above, but is not limited thereto.

In an embodiment, the wireless communication method includes selecting, by a first wireless communication terminal, a first wireless communication path (e.g., a PCS path) or a second wireless communication path (e.g., a Uu path) for a service to communicate with a second wireless communication terminal according to a path status. The first wireless communication path is a direct communication path between the first wireless communication terminal and the second wireless communication terminal, and the second wireless communication path is a communication path between the first wireless communication terminal and the second wireless communication terminal via a random access network and a core network.

In an embodiment, the path status comprises at least one of: whether a first link via the first wireless communication path exists, whether a second link via the second wireless communication path exists, a first link quality of the first wireless communication path, or a second link quality of the second wireless communication path.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques.

For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
selecting, by a first wireless communication terminal, a first wireless communication path or a second wireless communication path for a service to communicate with a second wireless communication terminal according to a path status;
wherein the first wireless communication path is a direct communication path between the first wireless communication terminal and the second wireless communication terminal, and the second wireless communication path is a communication path between the first wireless communication terminal and the second wireless communication terminal via a random access network and a corresponding core network.

2. The wireless communication method of claim 1, wherein the first wireless communication path is a communication path between the first wireless communication terminal and the second wireless communication terminal via a PCS interface.

3. The wireless communication method of claim 1, wherein the second wireless communication path is a communication path between the first wireless communication terminal and the second wireless communication terminal via a Uu interface.

4. The wireless communication method of claim 1, wherein the path status comprises at least one of: whether a first link via the first wireless communication path exists, or whether a second link via the second wireless communication path exists.

5. The wireless communication method of claim 1, wherein if either a first link via the first wireless communication path or a second link via the second wireless communication path is not existing, the path status comprises at least one of: a first link quality of the first wireless communication path, or a second link quality of the second wireless communication path.

6. The wireless communication method of claim 1, wherein the first wireless communication terminal is configured to use a first link via the first wireless communication path for the service to communicate with the second wireless communication terminal in response to the first link existing.

7. The wireless communication method of claim 1, wherein the first wireless communication terminal is configured to use a second link via the second wireless communication path for the service to communicate with the second wireless communication terminal in response to the second link existing.

8. The wireless communication method of claim 1, wherein the first wireless communication terminal is configured to use a first link via the first wireless communication path for the service to communicate with the second wireless communication terminal in response to a path selection policy indicating that the first wireless communication path is a preferred path for the service.

9. The wireless communication method of claim 1, wherein the first wireless communication terminal is configured to use a first link via the first wireless communication path for the service to communicate with the second wireless communication terminal in response to a first link quality of the first wireless communication path being better than a second link quality of the second wireless communication path.

10. The wireless communication method of claim 1, wherein the first wireless communication terminal is configured to use a second link via the second wireless communication path for the service to communicate with the second wireless communication terminal in response to a path selection policy indicating that the second wireless communication path is a preferred path for the service.

11. A wireless communication terminal, comprising:
a communication unit; and
a processor configured to select a first wireless communication path or a second wireless communication path for a service to communicate with a second wireless communication terminal according to a path status,
wherein the first wireless communication path is a direct communication path between the first wireless communication terminal and the second wireless communication terminal, and the second wireless communication path is a communication path between the first wireless communication terminal and the second wireless communication terminal via a random access network and a corresponding core network.

12. The wireless communication terminal of claim 11, wherein the first wireless communication terminal is configured to use a second link via the second wireless communication path for the service to communicate with the second wireless communication terminal in response to the second link existing.

13. The wireless communication terminal of claim 11, wherein the first wireless communication terminal is configured to use a first link via the first wireless communication path for the service to communicate with the second wireless communication terminal in response to a path selection policy indicating that the first wireless communication path is a preferred path for the service.

14. The wireless communication terminal of claim 11, wherein the first wireless communication terminal is configured to use a first link via the first wireless communication path for the service to communicate with the second wireless communication terminal in response to a first link quality of the first wireless communication path being better than a second link quality of the second wireless communication path.

15. The wireless communication terminal of claim 11, wherein the first wireless communication terminal is configured to use a second link via the second wireless communication path for the service to communicate with the second wireless communication terminal in response to a path selection policy indicating that the second wireless communication path is a preferred path for the service.

16. The wireless communication terminal of claim 11, wherein the first wireless communication terminal is configured to use a second link via the second wireless communication path for the service to communicate with the second wireless communication terminal in response to a second link quality of the second wireless communication path being better than a first link quality of the first wireless communication path.

17. The wireless communication terminal of claim 11, wherein there is no link on the first wireless communication path and the second wireless communication path available for the service.

18. The wireless communication terminal of claim 11, wherein the first wireless communication terminal is configured to perform a link quality measurement for a PCS interface to acquire a first link quality of the first wireless communication path.

19. The wireless communication terminal of claim 11, wherein the first wireless communication terminal is configured to perform a link quality measurement for a Uu interface to acquire a second link quality of the second wireless communication path.

20. The wireless communication terminal of claim 11, wherein a path selection policy indicates that both of the first wireless communication path and the second wireless communication path are able to be selected for the service to communicate with the second wireless communication terminal.
